(19) United States
(12) Patent Application Publication
(10) Pub. No.: US 2010/0077805 A1
(43) Pub. Date: Apr. 1, 2010

(54) OUTSIDE ACTUATION FOR LOCKS ON DOORS, TAILGATES AND THE LIKE

(76) Inventors: Dirk Mueller, Essen (DE); Ralf Lennhoff, Hagen (DE); Sascha Pfeiffer, Wuppertal (DE)

Correspondence Address: HORST M KASPER, 13 FOREST DRIVE, WARREN, NJ, 07059, US

(21) Appl. No.: 12/450,547

(22) PCT Filed: Feb. 13, 2008
(86) PCT No.: PCT/EP2008/001208

§ 371 Date: Sep. 29, 2009

(30) Foreign Application Priority Data
Apr. 3, 2007 (DE) 10 2007 016 351.9

(51) Int. Cl. E05B 17/10; E05B 65/00; B60Q 1/26

(52) U.S. Cl. 70/91; 362/501; 362/100

(57) ABSTRACT

The invention relates to an outside actuation system for locks on doors, tailgates, or the like of motor vehicles (20). The outside actuation system has a handle (10) which is arranged on the outer side (22) of the door (21) and which can serve for opening the door (21). The handle (10) is fixed pivotably on a bearing axis (11). In addition, a grip recess is designed to be on the outer side (22) of the door (21) in the area of the handle (10), which grip recess can be illuminated by an illuminating device (30). Said illuminating device (30) comprises a housing (31) which is designed as a part of the handle (10) and which is located near the bearing axis (11). Said illuminating device (30) illuminates not only the grip recess but also simultaneously the area outside the vehicle (23) which is located on the ground (24) near the vehicle door (21).

The invention relates to a device of the kind indicated in the preamble of claim 1. The handle is captured by the hand of the user and actuated for opening the door and for entering into a vehicle for example. It is sensible to illuminate the region such that the handle can be securely gripped by the user. The user can thus see the handle and securely capture it. A feeling and a touching of the handle is therefore not required.

The German printed Patent document DE 101 21 046 A1 describes such a device, where an electrically operated sensor is disposed in the interior of the handle and detects the approach of an authorized access user. The handle exhibits one or several bore holes, which serve for receiving a light source. This light source is connected to the electrical supply lines of the sensor placed into the interior of the handle, wherein the electronics of the sensor turns on the light source. In particular, two light sources are furnished at the handle, which light sources illuminate the grip recess from each end of the handle. However, it is a disadvantage in this arrangement that the user, who wants to actuate the handle in darkness, cannot recognize the floor near the vehicle door such that the danger exists to trip or stumble, to step into a puddle, or the like. In addition, the guiding of the electrical lines to the light source disposed at the second end is difficult. The light sources in the bore holes at the handle also do not result in a connected optical image.

Therefore it is an object of the present invention to furnish a device, which can simultaneously illuminate the region of the handle and the front field disposed at the floor, which front field thereby offers an optically pleasant picture of the handle and which device is simple for mounting. This object is obtained by the characterizing features of claim 1, which features have the following particular importance and meaning.

The illuminating device comprises a housing, which housing is formed as a part of the handle itself and which is arranged close to the bearing axis. This casing together with the handle forms a common unit. The illuminating device illuminates both the grip recess as well as also the front field disposed at the floor next to the vehicle door. Therefore the user cannot only recognize well the grip recess, but also the floor near to the vehicle door such that a twisting or a tripping or a stumbling or also a stepping into a puddle can be avoided. Here the handle and the casing form a unit from the appearance image such that a positive optical impression is generated. The casing and the handle can be led together into a device unit already prior to the mounting of the handle at the vehicle. The mounting of the handle at the vehicle is thereby rendered more simple. It is also possible to provide for the illuminating device at a multitude of different handles, which handles can also contain but do not have to contain further electronic components such as for example sensors.

The switching on of the illuminating device can for example be performed by a sensor within the handle, wherein the sensor detects the approach of the authorized user. It is also possible to turn the illuminating device on by an actuating of the key for opening the door lock. This key can in particular also be presented by an electronic device component, which is furnished with keys for touching or the like and which communicates with the vehicle by for example electromagnetic waves. It is also advantageous to turn on the illuminating device by switching off the motor at the motor vehicle. Usually the operating person leaves the vehicle after the switching off of the motor. Then it is sensible to be able to see the front field disposed at the floor in order to avoid to step here onto an unevenness or into a puddle. It is also advantageous to illuminate the region of the grip recess in order to be able to actuate for example keys for touching, switches or the like disposed at the handle. Of course, still further possibilities are conceivable for switching on the illuminating device.

Further advantages and embodiments of the invention result from the following description, the subclaims, and the drawings. There is shown in:

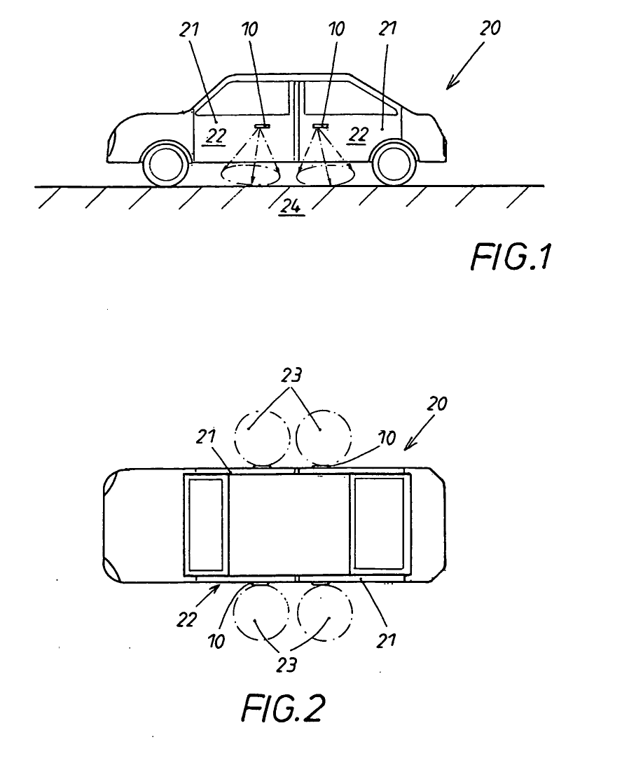

FIG. 1 a side elevational view of a vehicle with the invention device and illuminated regions in the front field,

FIG. 2 a top planar view of the vehicle of FIG. 1,

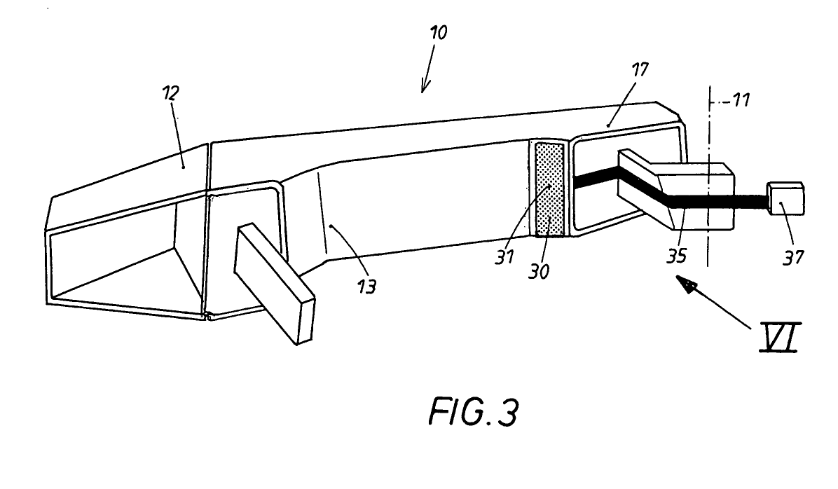

FIG. 3 a perspective view of the invention handle,

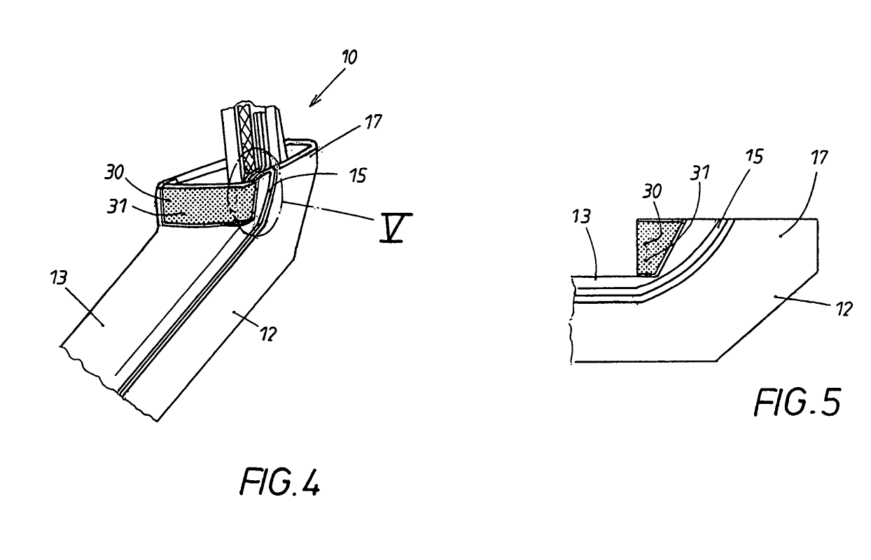

FIG. 4 a different perspective view from below of a part of the handle from FIG. 3,

FIG. 5 a sectional view V from FIG. 4 in an enlarged representation from below,

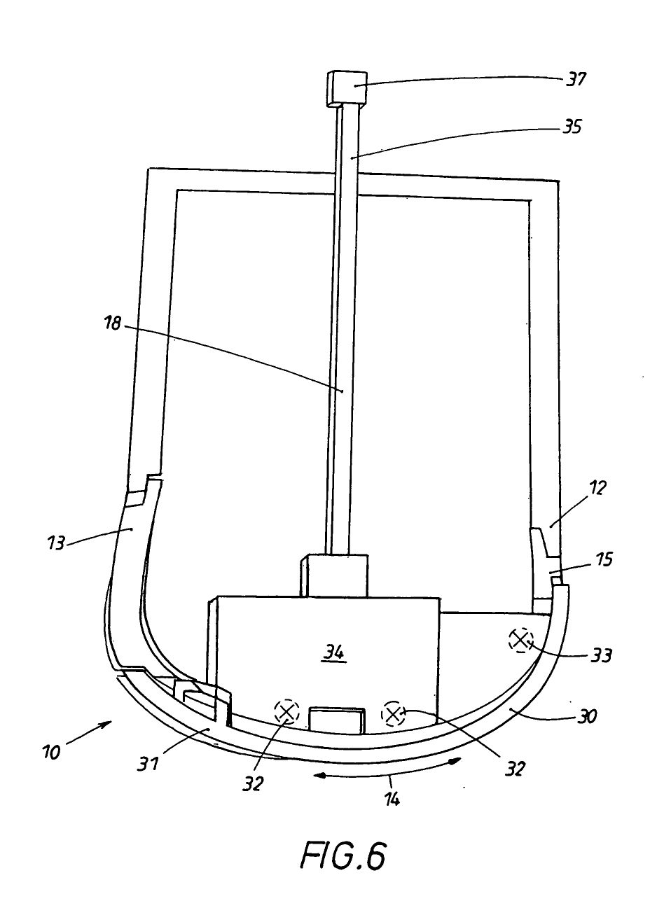

FIG. 6 a top planar view onto the end of the handle of FIG. 3 as seen from the arrow VI,

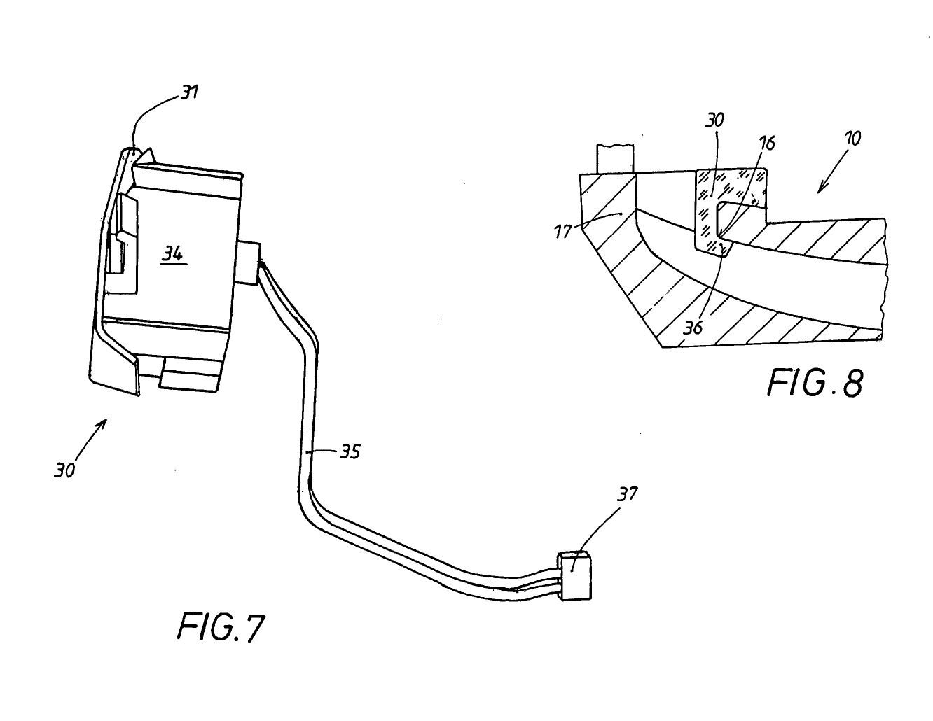

FIG. 7 a view of an illuminating device according to the present invention,

FIG. 8 a detail sectional view of a handle according to the present invention.

The FIGS. 1 and 2 show a vehicle 20 with the outside actuation according to the present invention. Handles 10 can be recognized at the doors 21 of the vehicle 20. The handles 10 are disposed at the outer sides 22 of the doors 21. A grip recess here not shown in detail is disposed between the handle 10 and the outer sides 22. The respective front field 23 is illuminated in addition to the grip recesses with turned on illuminating devices 30, which front field 23 is disposed on the floor 24 lateral to the respective door 21. Here a situation is shown in FIG. 2, where the motor vehicle 20 exhibits four doors 21, which doors 21 each have available a handle 10, wherein the handle 10 is equipped with an illuminating device 30. All front fields 23 are thereby illuminated by the illuminating devices 30. It is of course also possible to furnish a vehicle 20 with a smaller number of doors 21 or for example to arrange the illuminating device 30 only at the door of the driver.

The handle 10 according to the present invention is shown in FIG. 3, wherein the handle 10 exhibits the illuminating device 30 at the end 17 of the handle 10 disposed close to the bearing axis 11. The handle 10 is here formed from two parts and has a diaphragm part 12 and a grip body 13. The housing 31 of the illuminating device 30 is formed as a part of the grip body 13. Also still further electrical or electronic device components can be furnished in the bow shaped handle 10 such as for example sensors, switches, antennas, emitter-receiver units and the like. The electrical connection cables 35 of the illuminating device 30 are led further over the end 17 of the handle 10 coordinated to the bearing axis 11 and the electrical connection cables 35 are connected from there to the power supply and/or to the steering or control of the vehicle 20. This arrangement is advantageous for the reason that little of mechanical loads act on the electrical connection cables 35 close to the bearing axis 11. Therefore hardly any damages occur, which damages could cause for example electrical shorts.

It is particularly advantageous to guide the electrical connection cables 35 into a plug 37, which plug 37 simply can be connected to the power supply or, respectively, the steering or control of the vehicle 20 by way of a suitable socket, not shown here in detail, in the vehicle 20. If the handle 10 contains still further electronic components, then also the electrical lines 18 required for this purpose can also be connected to the plug 37. This simplifies the mounting of the handle 10, since as already mentioned above contacting to the power supply or, respectively, to the steering or to the control of the vehicle 20 is therewith rendered easier.

FIG. 4 shows again somewhat more detailed the end 14 of the handle 10 on the side of the bearing axis 11. This part is illustrated here out of a different perspective as compared with FIG. 3, namely inclined from below. One recognizes that the housing 31 of the illuminating device 30 extends here in radial direction 14 further in the direction of floor 24, as toward the other direction. This is associated with the advantage that the front field 23 becomes well illuminated, however without blinding or dazzling the operating person by allowing upward illumination of the light from the handle 10.

FIG. 5 shows a section from FIG. 4 in an enlarged representation. Here one recognizes that the housing 31 of the illuminating device 30 forms a part of the grip body 13. The housing 31 protrudes however in radial direction 14 not up to the diaphragm part 12. Instead the housing 31 is surrounded by a web like element 15 of the grip body 13. This is associated with the advantage that no position is generated at the groove between the grip body 13 and the diaphragm part 12, at which position three device components meet each other. Such positions are unfavorable because a uniform picture can be reached only with difficulties because of production tolerances and such positions present also always weak points with regard to the strength.

FIG. 6 shows the illumination device 30 in the incorporated state in detail. The upper part of the housing 31 of the illuminating device 30 is not illustrated in order to be able to illustrate in more detail the inner construction of illuminating device 30. The illuminating device 30 contains a circuit board 34 through which the current supply and the control of the light sources 32,33 is performed. Light emitting diodes LED are here preferably employed as light sources 32,33, since the light emitting diodes have a low current use and also will not become hot such that the operating person can touch the handle 10 without danger also after a longer illumination time.

The first light sources 32 are disposed at the circuit board 34, which light sources 32 are disposed below the circuit board in FIG. 6 and therefore are illustrated with dashed lines. These first light sources 32 illuminate the grip recess of the vehicle 20. In addition to this there is furnished also a second light source 33, which second light source 33 is disposed also below the circuit board 34 and which second light source 33 has the purpose to illuminate the front field 23. This second light source 33 is also located in the region of the housing 31 disposed in the direction of the floor 24 and this second light source 33 lies therefore in radial direction 14 also closer in the region of the floor 24 as compared with the first light sources 32. The second light source 33 should be aligned in the direction of the floor 24 in order to accomplish an illumination as good as possible of the front field 23; the first light sources 32 are directed in the direction of the grip recess.

Here one can also recognize that the handle 10 comprises a diaphragm part 12 and a grip body 13. The housing 31 matches very well the shape of the grip body 13. The web like element 15 of the grip body 13 is recognized between the housing 31 and the diaphragm part 12 on the side of the handle 10 which is directed toward the floor 24. The electrical connection cables 35, which are connected at the circuit board 34, end in a plug 37, which plug can be simply connected in the vehicle. In addition also electrical lines 18 are connected at this plug 37, which electrical lines 18 are derived from the electrical or, respectively, electronic device components out of the interior of the handle 10.

FIG. 7 now shows the illuminating device 30. This illuminating device 30 forms a compact device group, which compact device group can be mounted simple and quick in the handle 10. The plug 37 is also here connected to the electrical connection cables 35. In this case no further electrical lines 18 are furnished. The form of the plug 37 depends on the respective case of application.

Finally, FIG. 8 shows the application of the illuminating device 30 in a single part formed handle 10. The handle 10 is however here only illustrated by way of example. Just the same it is conceivable to furnish this embodiment at a multi-part handle 10.

The handle 10 has the locking means 16. The illuminating device 30 is furnished with counter locking means 36. During incorporation of the illuminating device 30, the counter locking means 36 is locked at the locking means 16 such that a secure and firm connection exists and the illuminating device 30 and the handle 10 form a closed device group, which device group can be mounted at a vehicle 20. Preferably the handle 10 as well as also the housing 31 of the illuminating device 31 consist of plastic. In this case it is particularly advantageous to form the locking means 16 or, respectively, the counter locking means 36 already during the production process, for example by injection molding.

The here represented embodiments are only realizations by way of example of the invention. The invention is not restricted to these embodiments. Instead many kinds of deviations and modifications are possible.

### LIST OF REFERENCE CHARACTERS

10 handle
11 bearing axis
12 diaphragm part
13 grip body
14 radial direction of 13
15 web like element of 13
16 locking means
17 end of 10 near 11
18 electrical line
20 motor vehicle
21 door
22 outer side of 21
23 front field
24 floor
30 illuminating device
31 housing
32 first light sources
33 second light sources
34 circuit board
35 electrical connection cables
36 counter locking means
37 plug

1. Outside actuation system for locks at doors (21),
hatches, and the like at a motor vehicle (20),
with a handle (10), which handle (10) is disposed at the outer side (22) of the door (21) and can serve for opening the door (21),
wherein the handle (10) has a bearing axis (11), wherein the handle (10) is pivotably supported at the bearing axis (11),
with a grip recess, wherein the grip recess is formed at the outside (22) of the door (21) in the region of the handle (10), and
with an illuminating device (30), wherein the grip recess and a front field (23) disposed at the floor (24) lateral to the vehicle door (21) are also simultaneously illuminated through the illuminating device (30),
characterized in that the illuminating device (30) comprises a housing (31), which housing (31) is formed as part of the handle (10) and is disposed close to the bearing axis (11), and
wherein one or several light sources (32,33) are placed in the casing (31) of the illuminating device (30).

2. Outside actuation system according to claim 1, wherein one or several light emitting diodes (LED) serve as light sources (32,33) in the illuminating device (30).

3. Outside actuation system according to claim 1, wherein the illuminating device (30) includes a circuit board (34), which circuit board (34) furnishes the current supply and the control of the light sources (32,33).

4. Outside actuation system according to claim 1, wherein the illuminating device (30) comprises several light sources (32,33), of which one or several first light sources (32) illuminate the region of the grip recess and one or several second light sources (33) illuminate front field (23).

5. Outside actuation system according to claim 1, wherein the handle (10) is formed as a single part.

6. Outside actuation system according to claim 1, wherein the handle (10) is formed from several parts, wherein these parts comprise at least a grip body (13) and a diaphragm part (12).

7. Outside actuation system according to claim 6, wherein the housing (31) of the illuminating device (30) forms a part of the grip body (13).

8. Outside actuation system according to claim 7, wherein the illuminating device (30) extends into a radial direction (14) of the grip body (13) further in the direction of the floor (24) than into the other direction.

9. Outside actuation system according to claim 7, wherein the housing (31) of the illuminating device (30) does not extend up to the diaphragm part (12) but then at least a web like formed element (15) of the grip body (13) contains or grips around the housing (31) in radial direction (14).

10. Outside actuation system according to claim 1, wherein the illuminating device (30) comprises electrical connection cables (35), which electrical connection cables (35) are fed over the end (17) coordinated to the bearing axis (11) of the handle (10) to a current supply and/or to a control.

11. Outside actuation system according to claim 10, wherein the electrical connection cable (35) are connectable to a plug (37), wherein the plug (37) is connectable to the power supply of the vehicle (20).

12. Outside actuation system according to claim 11, wherein also electrical conduits (18) of other electronic parts disposed in the handle (10) are connectable to the plug (37).

13. Outside actuation system according to claim 1, wherein the handle (10) exhibits locking means (16), wherein the illuminating device (30) includes counter locking means (36),
and wherein the counter locking means (36) of the illuminating device (30) is lockable with the locking means (16) of the handle (10), whereby an incorporated state is generated.

14. Outside actuation system according to claim 1, wherein the handle (10) and/or the housing (31) of the illuminating device (30) are made of plastic.

15. Outside actuation system according to claim 13, wherein the handle (10) and/or the housing (31) are produced by injection molding and wherein the locking means (16) and/or the counter locking means (36) are formed already during the production process.

16. Outside actuation system according to claim 1, wherein the illuminating device (13) is switched on by approach of an authorized user.

17. Outside actuation system according to claim 1, wherein the illuminating device (30) is switched on by actuation of the key for opening of the lock.

18. Outside actuation system according to claim 1, wherein the illuminating device (30) is switched on by switching off the motor of the motor vehicle (20).
